(19) United States
(12) Patent Application Publication
(10) Pub. No.: US 2019/0099788 A1
(43) Pub. Date: Apr. 4, 2019

(54) DRILL DRIVE NEEDLESCALER TOOL

(71) Applicant: Carl Eckhold, Monmouth, OR (US)

(72) Inventor: Carl Eckhold, Monmouth, OR (US)

(21) Appl. No.: 15/724,279

(22) Filed: Oct. 4, 2017

(51) Int. Cl. B08B 7/02; B25F 5/02

(52) U.S. Cl. CPC B08B 7/022; B25D 2250/291; B25F 5/02; B08B 7/024

(57) ABSTRACT

A drill drive needlescaler tool includes a drill mechanism, a handle attached to and extending downwardly from a bottom side of the drill mechanism, and a needlescaler mechanism attached to a forward side of the drill mechanism and extending forwardly therefrom to enable contact with a work site. The drill and needlescaler mechanisms are adapted to generate motions that result in removal of slag and rust from the work site.

### BACKGROUND OF THE INVENTION

### 1. Field of the Invention

The present general inventive concept relates generally to the process of removing dirt, built-up slag and rust before welding and, more particularly, to a drill drive needlescaler tool.

### 2. Description of the Related Art

Many construction workers utilize air compressors to clear out dust and rust. However, conventional air compressors are extremely heavy and corded which impose restrictions on iron workers and welders to perform their jobs in a small area around their work site.

Therefore, there is a need for an approach that will relieve these workers of work area restrictions so that they may perform their jobs effortlessly around their work sites.

### SUMMARY

The present general inventive concept provides a drill drive needlescaler tool.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a drill drive needlescaler tool. The tool may include a drill mechanism, a handle attached to and extending downwardly from a bottom side of the drill mechanism, and a needlescaler mechanism attached to a forward side of the drill mechanism and extending forwardly therefrom to provide contact with a work site, the drill and needlescaler mechanisms being adapted to generate motions that causes removal of slag and rust from the work site.

The drill mechanism of the tool may include a drill housing, a rotary drive in the drill housing, and a drill chuck mounted to the drill housing.

The needlescaler mechanism of the tool may include a needlescaler housing, a reciprocatory drive in the needlescaler housing, and a set of needle pins mounted to a forward side of the needlescaler housing and drivingly coupled to the reciprocatory drive.

The rotary drive of the drill mechanism of the tool may be drivingly coupled to the reciprocatory drive of the needlescaler mechanism such that the motions generated are reciprocatory and rotary motions.

The tool also may include a battery pack mounted to the handle to supply electrical power to the drill mechanism.

The tool also may include a plurality of LED lights mounted to the needlescaler mechanism so as to project light in a forwardly direction therefrom.

The tool also may include a lanyard loop attached to the handle.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a side view of a drill drive needlescaler tool, according to an exemplary embodiment of the present general inventive concept;

FIG. 2 is a rear view of the drill drive needlescaler tool of FIG. 1; and

FIG. 3 is a side view of a cordless, battery-operated, drill drive needlescaler tool, according to another exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

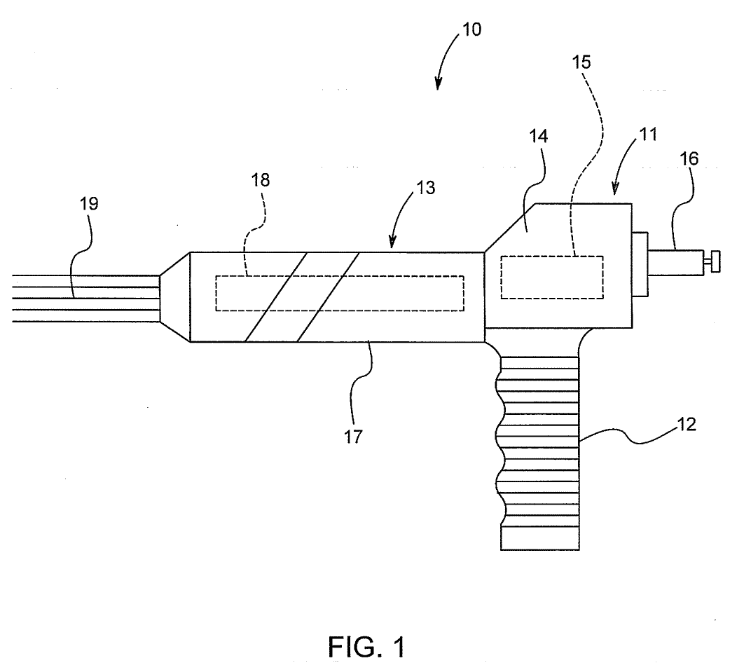

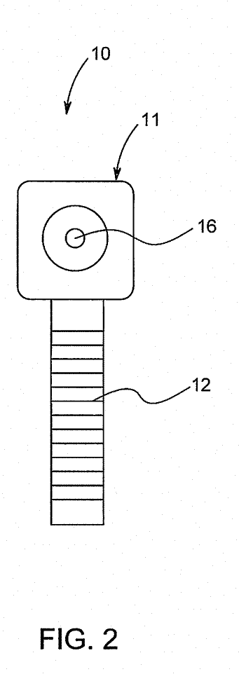

Referring to FIGS. 1 and 2, a drill drive needlescaler tool 10, according to an exemplary embodiment of the present general inventive concept, is illustrated. The drill drive needlescaler tool 10 may include a drill mechanism 11, a handle 12 attached to and extending downwardly from a bottom side of the drill mechanism 11, and a needlescaler mechanism 13 attached to a forward side of the drill mechanism 11 and extending forwardly therefrom to provide contact with a work site (not shown). The drill and needlescaler mechanisms 11, 13 are adapted to generate motions that cause removal of slag and rust from the work site.

More particularly, the drill mechanism 11 may include a drill housing 14, a rotary drive 15 in the drill housing, and a drill chuck 16 mounted to the drill housing. The needlescaler mechanism 13 may include a needlescaler housing 17, a reciprocatory drive 18 in the needlescaler housing, and a set of needle pins 19 mounted to a forward side of the needlescaler housing and drivingly coupled to the reciprocatory drive. The rotary drive 15 of the drill mechanism 11 may be drivingly coupled to the reciprocatory drive 18 of the needlescaler mechanism 13 such that the motions generated are reciprocatory and rotary motions.

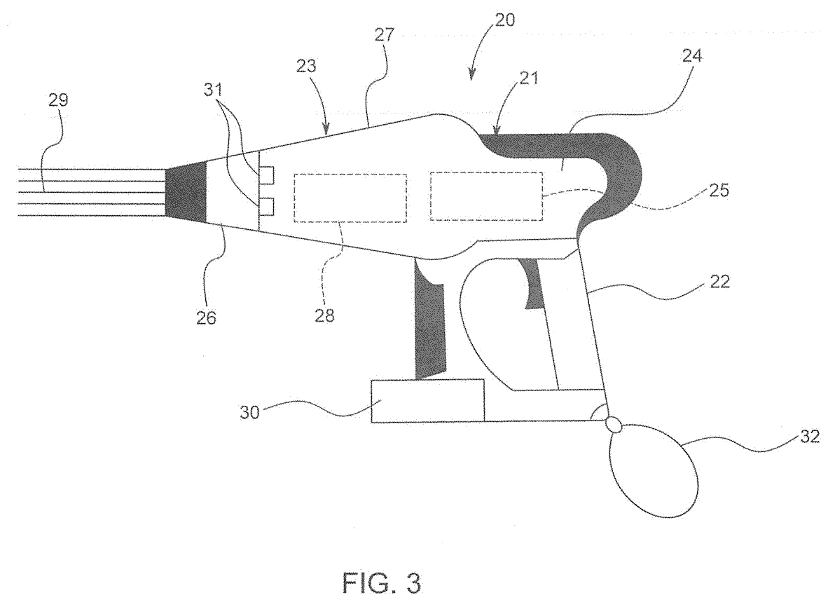

Referring to FIG. 3, a cordless, battery-operated, drill drive needlescaler tool 20, according to another exemplary embodiment of the present general inventive concept, is illustrated. The tool 20 may include a drill mechanism 21, a handle 22 attached to and extending downwardly from a bottom side of the drill mechanism 21, and a needlescaler mechanism 23 similar in arrangement to those of the tool 10. The drill and needlescaler mechanisms 21, 23 may be adapted to generate motions that cause removal of slag and rust from the work site.

More particularly, the drill mechanism 21 may include a drill housing 24, a rotary drive 25 in the drill housing, and a drill chuck 26 mounted to the drill housing. The needlescaler mechanism 23 may include a needlescaler housing 27, a reciprocatory drive 28 in the needlescaler housing, and a set of needle pins 29 mounted to a forward side of the needlescaler housing and drivingly coupled to the reciprocatory drive. The rotary drive 25 of the drill mechanism 21 may be drivingly coupled to the reciprocatory drive 28 of the needlescaler mechanism 23 such that the motions generated are reciprocatory and rotary motions.

Also, the tool 20 may have a battery pack 30 mounted to the handle 22 to supply electrical power to the drill mechanism 21. Further, the tool 20 may have a plurality of lights 31 mounted to the needlescaler housing 27 of the needlescaler mechanism 23 so as to project light in a forwardly direction therefrom. Still further, the tool 20 may have a lanyard loop 32 attached to the handle 22.

The tools 10, 20 of both embodiments may measure up to 18 inches in length and contain an 18 volt battery pack. The lights 31 may be LED work lights for optimal utilization. The tools 10, 20 may be manufactured with steel an high impact plastic for durability and portability. The tools 10, 20 are easy to use for scaling a surface of metal and completely removing all residual dirt and particles, leaving behind a surface that is ready to be bonded.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A drill drive needlescaler tool, comprising:
a drill mechanism;
a handle attached to and extending downwardly from a bottom side of the drill mechanism; and
a needlescaler mechanism attached to a forward side of the drill mechanism and extending forwardly therefrom to provide contact with a work site, the drill and needlescaler mechanisms being adapted to generate motions that causes removal of slag and rust from the work site.

2. The tool of claim 1, wherein the drill mechanism includes a drill housing, a rotary drive in the drill housing, and a drill chuck mounted to the drill housing.

3. The tool of claim 2, wherein the needlescaler mechanism includes a needlescaler housing, a reciprocatory drive in the needlescaler housing, and a set of needle pins mounted to a forward side of the needlescaler housing and drivingly coupled to the reciprocatory drive.

4. The tool of claim 3, wherein the rotary drive of the drill mechanism is drivingly coupled to the reciprocatory drive of the needlescaler mechanism such that the motions generated are reciprocatory and rotary motions.

5. The tool of claim 1, further comprises a battery pack mounted to the handle to supply electrical power to the drill mechanism.

6. The tool of claim 1, further comprises a plurality or LED lights mounted to the needle scaler mechanism so as to project light in a forwardly direction therefrom.

7. The tool of claim 1, further comprises a lanyard loop attached to the handle.
